(19) United States
(12) Patent Application Publication
(10) Pub. No.: US 2026/0368931 A1
(43) Pub. Date: Nov. 19, 2026

(54) COLOR CALIBRATION SYSTEM AND COLOR CALIBRATION METHOD FOR MULTI-LENS PANORAMA CAMERA

(71) Applicant: ASPEED Technology Inc., Hsinchu City (TW)

(72) Inventor: Chieh-Cheng Liao, Hsinchu City (TW)

(73) Assignee: ASPEED Technology Inc., Hsinchu City (TW)

(21) Appl. No.: 19/358,386

(22) Filed: Oct. 14, 2025

(30) Foreign Application Priority Data
May 16, 2025 (TW) 114118392

(51) Int. Cl. G06T 7/80; G06T 3/4038; H04N 23/88

(52) U.S. Cl. CPC G06T 7/80; G06T 3/4038; H04N 23/88; G06T 2207/10024

(57) ABSTRACT

Provided are a color calibration system and a color calibration method for a multi-lens panorama camera. The color calibration method includes the following. A stitched image is received from the multi-lens panorama camera. The stitched image is detected to obtain a first value corresponding to a first lens and a first color, and a second value corresponding to a second lens and the first color. In response to the first value being greater than the second value, a first gain of the second lens is calibrated according to the first value to generate a calibration result. Also, the calibration result is output.

### CROSS-REFERENCE TO RELATED APPLICATION

This application claims the priority benefit of Taiwan application serial no. 114118392, filed on May 16, 2025. The entirety of the above-mentioned patent application is hereby incorporated by reference herein and made a part of this specification.

### BACKGROUND

### Technical Field

The disclosure relates to a camera calibration technology, and particularly relates to a color calibration system and a color calibration method for a multi-lens panorama camera.

### Related Art

Cameras are widely applied in various fields such as environmental monitoring, road safety, video conferencing, sports broadcasting, or vehicle safety equipment. The more viewing angles of an image, the more complete information users can obtain. To meet people's demand for wide-angle images, cameras often apply fisheye lenses to increase the viewing angle of images. However, the peripheral areas of images captured by conventional fisheye lenses often have disadvantages such as large image distortion, reduced resolution, or low light transmission. To address the above disadvantages, a multi-lens camera may be used to obtain multiple images corresponding to different viewing angles, and generate a stitched image according to the multiple images. However, to obtain a high-quality stitched image, the color difference between multiple lenses cannot be too high. In view of this, how to calibrate the color difference between different lenses is one of the important issues in this field.

### SUMMARY

The disclosure provides a color calibration system and a color calibration method for a multi-lens panorama camera, which may reduce the color difference between multiple lenses.

A color calibration system for a multi-lens panorama camera of the disclosure includes an electronic computing device. The electronic computing device is communicatively connected to the multi-lens panorama camera, in which the multi-lens panorama camera includes a first lens and a second lens, and the electronic computing device is configured to execute the following operations. A stitched image is received from the multi-lens panorama camera. The stitched image is detected to obtain a first value corresponding to the first lens and a first color, and a second value corresponding to the second lens and the first color. In response to the first value being greater than the second value, a first gain of the second lens is calibrated according to the first value to generate a calibration result. Also, the calibration result is output.

In an embodiment of the disclosure, the electronic computing device is configured to further execute the following operation. A gain corresponding to a luminance of the second lens is increased to calibrate the first gain.

In an embodiment of the disclosure, the electronic computing device is configured to execute the following operations. The second value is updated according to the first gain. Whether a difference between the first value and the updated second value is less than a threshold is determined. Also, in response to the difference being less than the threshold, the calibration result is generated according to the first gain.

In an embodiment of the disclosure, the electronic computing device is configured to execute the following operations. The stitched image is detected to obtain a third value corresponding to the first lens and a second color, and a fourth value corresponding to the second lens and the second color. Also, a second gain of the second lens for the second color is calibrated according to the third value to generate the calibration result.

In an embodiment of the disclosure, the electronic computing device is configured to execute the following operations. The fourth value is updated according to the second gain. Whether an absolute difference between the third value and the updated fourth value is less than a threshold is determined. Also, in response to the absolute difference being less than the threshold, the calibration result is generated according to the second gain.

In an embodiment of the disclosure, the gain of the luminance includes a gain corresponding to the first color and a gain corresponding to the second color.

In an embodiment of the disclosure, the color calibration system further includes a white surface. The white surface is configured to cover a first field of view of the first lens and a second field of view of the second lens.

In an embodiment of the disclosure, a reflectivity of the white surface is less than a threshold.

In an embodiment of the disclosure, a first distance from the first lens to the white surface equals a second distance from the second lens to the white surface.

In an embodiment of the disclosure, the color calibration system further includes a first light source and a second light source. The first light source is configured to illuminate a first portion of a first surface of the white surface with first uniform light. The second light source is configured to illuminate a second portion of the first surface with second uniform light, in which the second portion is opposite to the first portion.

A color calibration method for a multi-lens panorama camera of the disclosure, in which the multi-lens panorama camera includes a first lens and a second lens, and the color calibration method includes the following. A stitched image is received from the multi-lens panorama camera. The stitched image is detected to obtain a first value corresponding to the first lens and a first color, and a second value corresponding to the second lens and the first color. In response to the first value being greater than the second value, a first gain of the second lens is calibrated according to the first value to generate a calibration result. Also, the calibration result is output.

In an embodiment of the disclosure, the step of calibrating the first gain of the second lens according to the first value to generate the calibration result includes the following. A gain corresponding to a luminance of the second lens is increased to calibrate the first gain.

In an embodiment of the disclosure, the step of calibrating the first gain of the second lens according to the first value to generate the calibration result further includes the following. The second value is updated according to the first gain. Whether a difference between the first value and the updated second value is less than a threshold is determined. Also, in response to the difference being less than the threshold, the calibration result is generated according to the first gain.

In an embodiment of the disclosure, the color calibration method further includes the following. The stitched image is detected to obtain a third value corresponding to the first lens and a second color, and a fourth value corresponding to the second lens and the second color. Also, a second gain of the second lens for the second color is calibrated according to the third value to generate the calibration result.

In an embodiment of the disclosure, the step of calibrating the second gain of the second lens for the second color according to the third value to generate the calibration result includes the following. The fourth value is updated according to the second gain. Whether an absolute difference between the third value and the updated fourth value is less than a threshold is determined. Also, in response to the absolute difference being less than the threshold, the calibration result is generated according to the second gain.

In an embodiment of the disclosure, the gain of luminance includes a gain corresponding to the first color and a gain corresponding to the second color.

In an embodiment of the disclosure, the color calibration method further includes the following. A white surface is configured to cover a first field of view of the first lens and a second field of view of the second lens.

In an embodiment of the disclosure, a reflectivity of the white surface is less than a threshold.

In an embodiment of the disclosure, a first distance from the first lens to the white surface equals a second distance from the second lens to the white surface.

In an embodiment of the disclosure, the color calibration method further includes the following. A first light source is configured to illuminate a first portion of a first surface of the white surface with first uniform light. Also, a second light source is configured to illuminate a second portion of the first surface with second uniform light, in which the second portion is opposite to the first portion.

Based on the above, the color calibration system of the disclosure may minimize color differences between multiple lenses of the multi-lens panorama camera.

### BRIEF DESCRIPTION OF THE DRAWINGS

FIG. 1 illustrates a schematic view of a color calibration system for a multi-lens panorama camera according to an embodiment of the disclosure.

FIG. 2 illustrates a flowchart of color calibration for the multi-lens panorama camera according to an embodiment of the disclosure.

FIG. 3 illustrates a top view of the multi-lens panorama camera with two lenses according to an embodiment of the disclosure.

FIG. 4 illustrates a rear view of the multi-lens panorama camera with two lenses according to an embodiment of the disclosure.

FIG. 5 illustrates a side view of the multi-lens panorama camera with two lenses according to an embodiment of the disclosure.

FIG. 6 illustrates a schematic view of a field of view of the multi-lens panorama camera with two lenses according to an embodiment of the disclosure.

FIG. 7 illustrates a top view of the multi-lens panorama camera with three lenses according to an embodiment of the disclosure.

FIG. 8 illustrates a schematic view of a field of view of the multi-lens panorama camera with three lenses according to an embodiment of the disclosure.

FIG. 9 illustrates a top view of the multi-lens panorama camera with four lenses according to an embodiment of the disclosure.

FIG. 10 illustrates a schematic view of a field of view of the multi-lens panorama camera with four lenses according to an embodiment of the disclosure.

FIG. 11 illustrates a flowchart of a color calibration method for the multi-lens panorama camera according to an embodiment of the disclosure.

### DESCRIPTION OF THE EMBODIMENTS

In order to make the content of the disclosure more comprehensible, the following embodiments are provided as examples that the disclosure can indeed be implemented based on. In addition, wherever possible, the same reference numerals used in the drawings and embodiments represent the same or similar components/elements/steps.

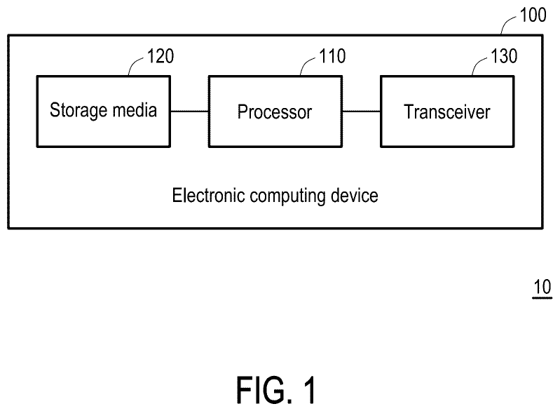

FIG. 1 illustrates a schematic view of a color calibration system 10 for a multi-lens panorama camera according to an embodiment of the disclosure. The color calibration system 10 may include an electronic computing device 100. The electronic computing device 100 may include a processor 110, a storage media 120, and a transceiver 130. The multi-lens panorama camera may have N lenses, where N is a positive integer greater than or equal to 2.

The processor 110 is, for example, a central processing unit (CPU), or other programmable general-purpose or special-purpose micro control unit (MCU), a microprocessor, a digital signal processor (DSP), a programmable controller, an application specific integrated circuit (ASIC), a graphics processing unit (GPU), an image signal processor (ISP), an image processing unit (IPU), an arithmetic logic unit (ALU), a complex programmable logic device (CPLD), a field programmable gate array (FPGA), or other similar components or combinations of the above components. The processor 110 may be coupled to the storage media 120 and the transceiver 130, and access and execute multiple modules and various applications stored in the storage media 120.

The storage media 120 is, for example, any type of fixed or removable random access memory (RAM), read-only memory (ROM), flash memory, hard disk drive (HDD), solid state drive (SSD), or similar components or combinations of the above components, used for storing multiple modules or various applications that may be executed by the processor 110.

The transceiver 130 transmits or receives signals in a wireless or wired manner. The transceiver 130 may further perform operations such as low-noise amplification, impedance matching, mixing, up or down frequency conversion, filtering, amplification, and similar operations. The processor 110 may communicate with the multi-lens panorama camera or external electronic devices through the transceiver 130 to receive or transmit data.

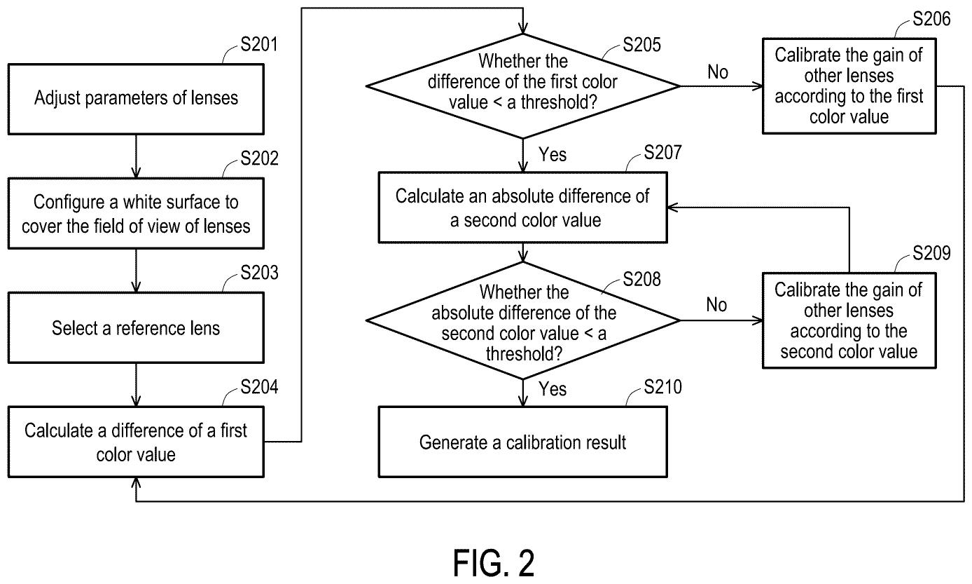

FIG. 2 illustrates a flowchart of color calibration for the multi-lens panorama camera according to an embodiment of the disclosure. The process in FIG. 2 may be implemented by the color calibration system 10 as shown in FIG. 1.

In Step S201, the processor 110 may adjust parameters of each lens of the multi-lens panorama camera to preset values. For example, the processor 110 may send instructions to the multi-lens panorama camera through the transceiver 130 to fix the parameters of each lens of the multi-lens panorama camera, where the parameters may include but are not limited to shutter time or analog gain.

In Step S202, a white surface may be configured to cover the field of view (FoV) of each lens of the multi-lens panorama camera.

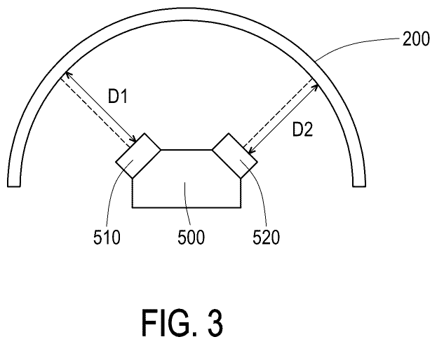

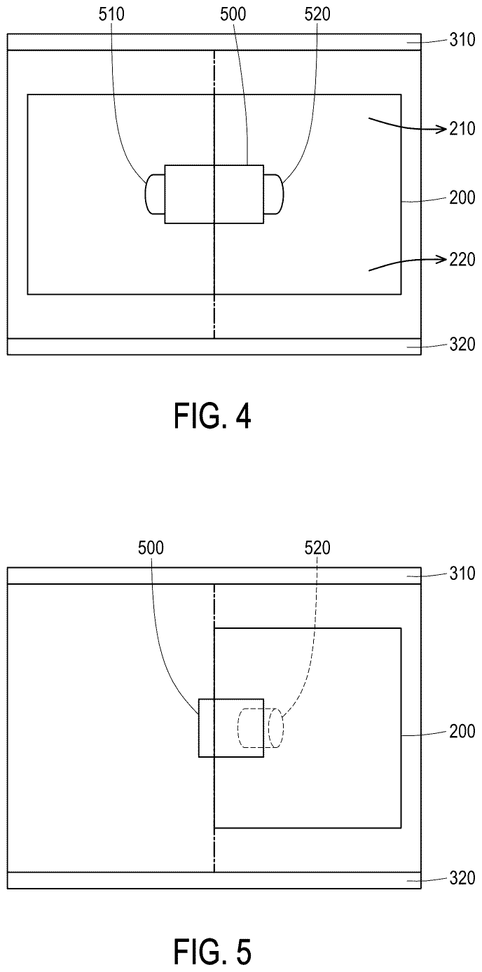

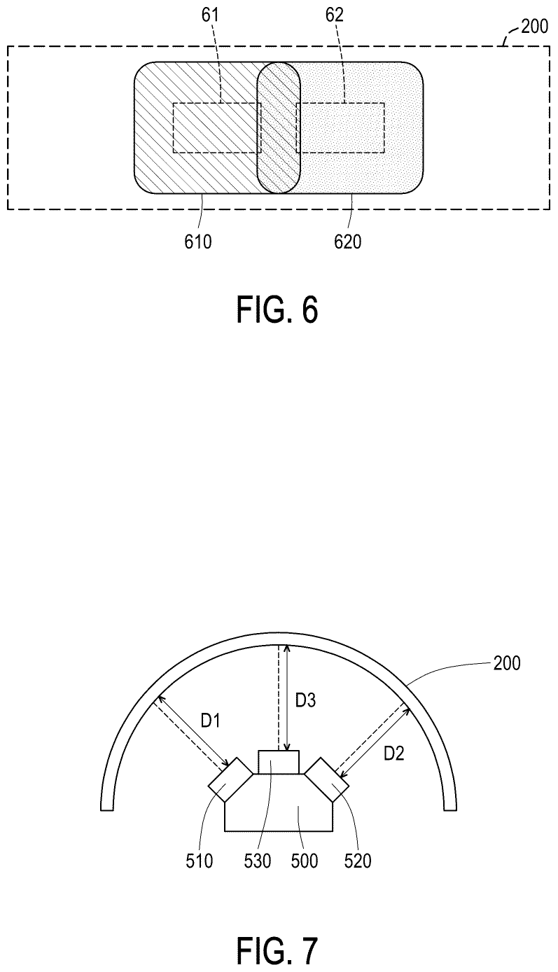

Taking a multi-lens panorama camera 500 with two lenses (that is, a lens 510 and a lens 520) as an example, FIG. 3 illustrates a top view of the multi-lens panorama camera 500 with two lenses according to an embodiment of the disclosure, FIG. 4 illustrates a rear view of the multi-lens panorama camera 500 with two lenses according to an embodiment of the disclosure, FIG. 5 illustrates a side view of the multi-lens panorama camera 500 with two lenses according to an embodiment of the disclosure, and FIG. 6 illustrates a schematic view of the field of view of the multi-lens panorama camera with two lenses according to an embodiment of the disclosure.

In an embodiment, the color calibration system 10 may further include a white surface 200. The material of the white surface 200 is, for example, paper or acrylic. The reflectivity of the white surface 200 may be less than a threshold. The white surface 200 may be configured to cover a field of view 610 of the lens 510 and a field of view 620 of the lens 520. The distance between all lenses of the multi-lens panorama camera 500 and the white surface 200 may be the same. For example, a distance D1 between the lens 510 and the white surface 200 may equal a distance D2 between the lens 520 and the white surface 200.

The color calibration system 10 may further include a light source 310 and a light source 320. The light source 310 may be configured to illuminate a portion 210 of a surface of the white surface 200 with uniform light, and the light source 320 may be configured to illuminate another portion 220 of the surface of the white surface 200 with uniform light, and the portion 220 is, for example, opposite to the portion 210. For example, if the portion 210 is the upper half portion of the surface of the white surface 200, then the portion 220 may be the lower half portion of the surface.

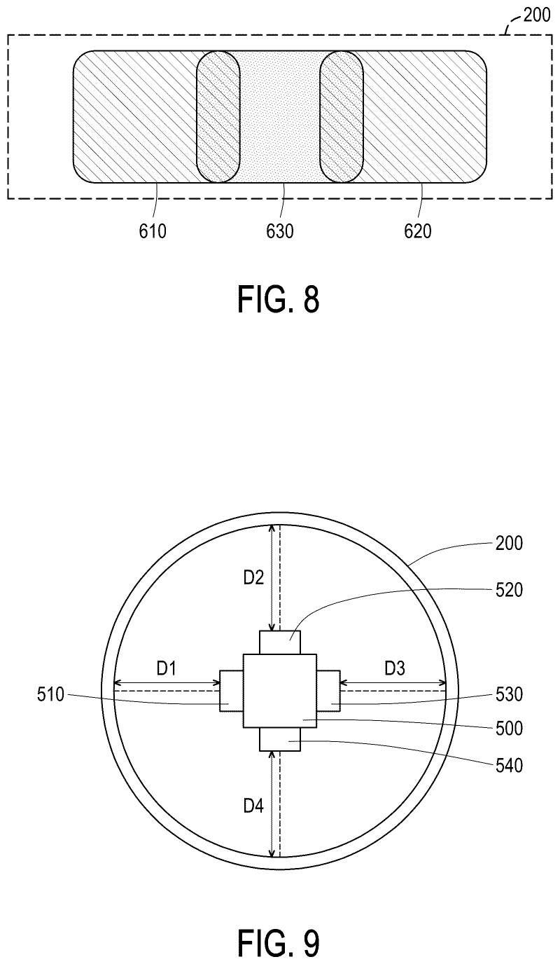

Taking a multi-lens panorama camera 500 with three lenses (that is, lenses 510, 520, and 530) as an example, FIG. 7 illustrates a top view of the multi-lens panorama camera 500 with three lenses according to an embodiment of the disclosure, and FIG. 8 illustrates a schematic view of the field of view of the multi-lens panorama camera 500 with three lenses according to an embodiment of the disclosure.

The white surface 200 may be configured to cover the field of view 610 of the lens 510, the field of view 620 of the lens 520, and a field of view 630 of the lens 530. The distance between all lenses of the multi-lens panorama camera 500 and the white surface 200 may be the same. For example, the distance D1 between the lens 510 and the white surface 200 may equal the distance D2 between the lens 520 and the white surface 200, and the distance D1 or the distance D2 may equal a distance D3 between the lens 530 and the white surface 200.

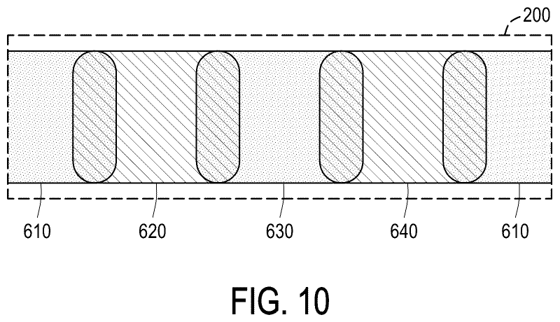

Taking a multi-lens panorama camera 500 with four lenses (that is, lenses 510, 520, 530, and 540) as an example, FIG. 9 illustrates a top view of the multi-lens panorama camera 500 with four lenses according to an embodiment of the disclosure, and FIG. 10 illustrates a schematic view of the field of view of the multi-lens panorama camera 500 with four lenses according to an embodiment of the disclosure.

The white surface 200 may be configured to cover the field of view 610 of the lens 510, the field of view 620 of the lens 520, the field of view 630 of the lens 530, and a field of view 640 of the lens 540. The distance between all lenses of the multi-lens panorama camera 500 and the white surface 200 may be the same. For example, the distance D1 between the lens 510 and the white surface 200 may equal the distance D2 between the lens 520 and the white surface 200. The distance D1 or the distance D2 may equal the distance D3 between the lens 530 and the white surface 200. The distance D1, D2, or D3 may equal a distance D4 between the lens 540 and the white surface 200.

Returning to FIG. 2, in Step S203, the processor 110 may select a reference lens from the multiple lenses of the multi-lens panorama camera 500.

Specifically, after the white surface 200 is set up, the multi-lens panorama camera 500 may capture multiple images corresponding to the white surface 200 through the multiple lenses respectively, and stitch the multiple images to generate a stitched image. The processor 110 may receive the stitched image from the multi-lens panorama camera 500 through the transceiver 130. The lens may capture an area of interest in the field of view. Taking FIG. 6 as an example, the lens 510 may capture an image containing at least a portion of the white surface 200 through an area of interest 61, where the area of interest 61 may be included in the field of view 610. On the other hand, the lens 520 may capture an image containing at least a portion of the white surface 200 through an area of interest 62, where the area of interest 62 may be included in the field of view 620.

In an embodiment, the area of interest 61 (or 62) and the field of view 610 (or 620) may have the same geometric center.

In an embodiment, the area of interest 61 (or 62) may partially overlap with the intersection of the field of view 610 and the field of view 620.

After obtaining the stitched image, the processor 110 may detect the stitched image to obtain a color value corresponding to the lens 510 (or the area of interest 61) and a first color, and a color value corresponding to the lens 520 (or the area of interest 62) and the first color. Generally, the proportion of green pixels to the total number of pixels is higher, so calibrating the green pixels first may speed up the calibration process. Accordingly, the processor 110 may define the first color as green color. That is, the processor 110 may detect the green color value corresponding to the area of interest 61 and the green color value corresponding to the area of interest 62 in the stitched image, respectively.

Next, the processor 110 may select the lens with the maximum color value of the first color as the reference lens, where the reference lens may be used to calibrate the gain of other lenses. For example, if the green color value corresponding to the lens 510 is greater than the green color value corresponding to the lens 520, then the processor 110 may select the lens 510 as the reference lens.

In Step S204, the processor 110 may calculate the difference of the first color value between the reference lens and other lenses. For example, the processor 110 may calculate the difference between the green color value of the lens 510 and the green color value of the lens 520.

In Step S205, the processor 110 may determine whether the difference of the first color value is less than a threshold. If the difference is less than the threshold, then Step S207 is executed. If the difference is greater than or equal to the threshold, then Step S206 is executed.

In Step S206, the processor 110 may calibrate the gain of other lenses according to the first color value of the reference lens. Then, the processor 110 may re-execute Step S204.

In an embodiment, the processor 110 may calibrate the gain of other lenses by increasing the gain of luminance corresponding to other lenses. The conversion of luminance to RGB values is shown in Formula (1), where Y value is the gain of luminance, R is the gain of red color, G is the gain of green color, and B is the gain of blue color. When the luminance of the lens increases, the gain of green color, the gain of red color, and the gain of blue color of the lens also increases.

Y=0.299*R+0.587*G+0.114*B (1)

For example, if the difference between the green color value of the lens 510 and the green color value of the lens 520 is greater than or equal to the threshold, the processor 110 may increase the gain of luminance corresponding to the lens 520 to calibrate the gain of the lens 520. After increasing the gain of luminance of the lens 520, the difference between the green color value of the lens 510 and the green color value of the lens 520 may be reduced.

After completing the calibration of the first color, in Step S207, the processor 110 may calculate the absolute difference of a second color value between the reference lens and other lenses.

The processor 110 may detect the stitched image to obtain the color value corresponding to the lens 510 (or the area of interest 61) and the second color, and the color value corresponding to the lens 520 (or the area of interest 62) and the second color. The processor 110 may define the second color as red or blue. In an embodiment, the second color value may be the ratio of the red color value to the blue color value. Then, the processor 110 may calculate the absolute difference of the second color value between the lens 510 and the lens 520.

In Step S208, the processor 110 may determine whether the absolute difference of the second color value is less than a threshold. If the absolute difference is less than the threshold, then Step S210 is executed. If the absolute difference is greater than or equal to the threshold, then Step S209 is executed.

In Step S209, the processor 110 may calibrate the gain of other lenses according to the second color value of the reference lens. Then, the processor 110 may re-execute Step S207.

In an embodiment, the processor 110 may calibrate the gain of other lenses by increasing or decreasing the gain of the second color (for example, blue or red) corresponding to other lenses. For example, the processor 110 may adjust the blue color gain and/or red color gain of the lens 520, so that the second color value of the lens 520 (for example, the ratio of the red color value to the blue color value) is closer to the second color value of the lens 510.

In Step S210, the processor 110 may generate a calibration result according to the gain obtained in Step S206 and the gain obtained in Step S209. The calibration result may include, for example, the gain of other lenses (for example, the lens 520), in which the gain may include the gain of luminance, the gain of the first color (for example, green), or the gain of the second color (for example, red or blue). The processor 110 may output the calibration result through the transceiver 130. For example, the processor 110 may transmit the calibration result to the multi-lens panorama camera 500. The multi-lens panorama camera 500 may perform color calibration according to the calibration result.

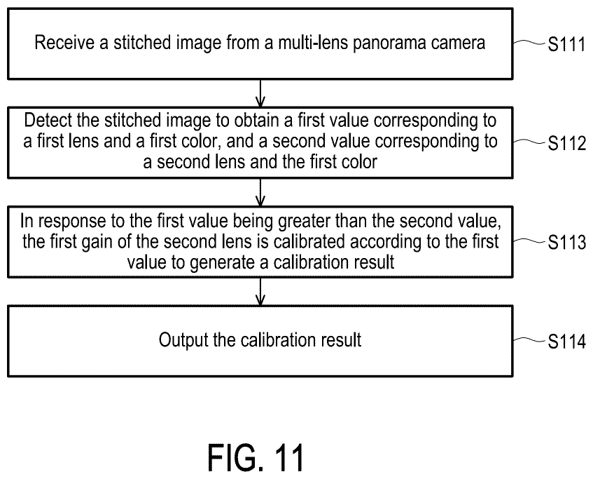

FIG. 11 illustrates a flowchart of a color calibration method for the multi-lens panorama camera according to an embodiment of the disclosure, in which the color calibration method may be implemented by the color calibration system 10. The multi-lens panorama camera may include a first lens and a second lens. In Step S111, a stitched image is received from the multi-lens panorama camera. In Step S112, the stitched image is detected to obtain a first value corresponding to the first lens and a first color, and a second value corresponding to the second lens and the first color. In Step S113, in response to the first value being greater than the second value, the first gain of the second lens is calibrated according to the first value to generate a calibration result. In Step S114, the calibration result is output.

In summary, the color calibration system of the disclosure uses a non-reflective white surface to cover the field of view of each lens of the multi-lens panorama camera, and uses uniform light to illuminate the white surface. The multi-lens panorama camera may capture a stitched image containing at least a portion of the white surface. The electronic computing device may detect the stitched image to obtain color values of each lens, and determine whether to calibrate the gain of each lens according to the color difference between multiple lenses. The electronic computing device may sequentially adjust the gain of green and red/blue to minimize the color difference between multiple lenses and generate a calibration result. The electronic computing device may use the calibration result to configure the multi-lens panorama camera, improving the quality of the stitched image generated by the multi-lens panorama camera.

What is claimed is:

1. A color calibration system for a multi-lens panorama camera, comprising:
an electronic computing device communicatively connected to the multi-lens panorama camera, wherein the multi-lens panorama camera comprises a first lens and a second lens, and the electronic computing device is configured to:
receive a stitched image from the multi-lens panorama camera;
detect the stitched image to obtain a first value corresponding to the first lens and a first color, and a second value corresponding to the second lens and the first color;
in response to the first value being greater than the second value, calibrate a first gain of the second lens according to the first value to generate a calibration result; and
output the calibration result.

2. The color calibration system as claimed in claim 1, wherein the electronic computing device is further configured to:
increase a gain corresponding to a luminance of the second lens to calibrate the first gain.

3. The color calibration system as claimed in claim 2, wherein the electronic computing device is further configured to:
update the second value according to the first gain;
determine whether a difference between the first value and the updated second value is less than a threshold; and
in response to the difference being less than the threshold, generate the calibration result according to the first gain.

4. The color calibration system as claimed in claim 2, wherein the electronic computing device is further configured to:
detect the stitched image to obtain a third value corresponding to the first lens and a second color, and a fourth value corresponding to the second lens and the second color; and
calibrate a second gain of the second lens for the second color according to the third value to generate the calibration result.

5. The color calibration system as claimed in claim 4, wherein the electronic computing device is further configured to:
update the fourth value according to the second gain;
determine whether an absolute difference between the third value and the updated fourth value is less than a threshold; and
in response to the absolute difference being less than the threshold, generate the calibration result according to the second gain.

6. The color calibration system as claimed in claim 2, wherein the gain of the luminance comprises a gain corresponding to the first color and a gain corresponding to the second color.

7. The color calibration system as claimed in claim 1, further comprising:
a white surface configured to cover a first field of view of the first lens and a second field of view of the second lens.

8. The color calibration system as claimed in claim 7, wherein a reflectivity of the white surface is less than a threshold.

9. The color calibration system as claimed in claim 7, wherein a first distance from the first lens to the white surface equals a second distance from the second lens to the white surface.

10. The color calibration system as claimed in claim 7, further comprising:
a first light source configured to illuminate a first portion of a first surface of the white surface with first uniform light; and
a second light source configured to illuminate a second portion of the first surface with second uniform light, wherein the second portion is opposite to the first portion.

11. A color calibration method for a multi-lens panorama camera, wherein the multi-lens panorama camera comprises a first lens and a second lens, and the color calibration method comprises:
receiving a stitched image from the multi-lens panorama camera;
detecting the stitched image to obtain a first value corresponding to the first lens and a first color, and a second value corresponding to the second lens and the first color;
in response to the first value being greater than the second value, calibrating a first gain of the second lens according to the first value to generate a calibration result; and
outputting the calibration result.

12. The color calibration method as claimed in claim 11, wherein calibrating the first gain of the second lens according to the first value to generate the calibration result comprises:
increasing a gain corresponding to a luminance of the second lens to calibrate the first gain.

13. The color calibration method as claimed in claim 12, wherein calibrating the first gain of the second lens according to the first value to generate the calibration result further comprises:
updating the second value according to the first gain;
determining whether a difference between the first value and the updated second value is less than a threshold; and
in response to the difference being less than the threshold, generating the calibration result according to the first gain.

14. The color calibration method as claimed in claim 12, further comprising:
detecting the stitched image to obtain a third value corresponding to the first lens and a second color and a fourth value corresponding to the second lens and the second color; and
calibrating a second gain of the second lens for the second color according to the third value to generate the calibration result.

15. The color calibration method as claimed in claim 14, wherein calibrating the second gain of the second lens for the second color according to the third value to generate the calibration result comprises:
updating the fourth value according to the second gain;
determining whether an absolute difference between the third value and the updated fourth value is less than a threshold; and
in response to the absolute difference being less than the threshold, generating the calibration result according to the second gain.

16. The color calibration method as claimed in claim 12, wherein the gain of the luminance comprises a gain corresponding to the first color and a gain corresponding to the second color.

17. The color calibration method as claimed in claim 11, further comprising:
configuring a white surface to cover a first field of view of the first lens and a second field of view of the second lens.

18. The color calibration method as claimed in claim 17, wherein a reflectivity of the white surface is less than a threshold.

19. The color calibration method as claimed in claim 17, wherein a first distance from the first lens to the white surface equals a second distance from the second lens to the white surface.

20. The color calibration method as claimed in claim 17, further comprising:
configuring a first light source to illuminate a first portion of a first side of the white surface with first uniform light; and
configuring a second light source to illuminate a second portion of the first side with second uniform light, wherein the second portion is opposite to the first portion.
